(19) United States
(12) Patent Application Publication
(10) Pub. No.: US 2016/0348411 A1
(43) Pub. Date: Dec. 1, 2016

(54) CASEMENT LATCH WITH FIX POSITION

(71) Applicant: Wan Lai Liau, New Taipei (TW)

(72) Inventor: Wan Lai Liau, New Taipei (TW)

(21) Appl. No.: 14/726,705

(22) Filed: Jun. 1, 2015

(51) Int. Cl. E05C 3/14

(52) U.S. Cl. CPC E05C 3/145

(57) ABSTRACT

A casement latch with fix position device includes a base including a shaft hole, first and second sets of two raise plates, and a slide accepter; two opposite blade springs each fastened between the raise plates of the first set of raise plates or the second set of raise plates; a rotary bolt including a shaft short side on a first surface, a shaft long side on an opposite second surface, a square through hole the first and shaft long sides, an engagement member, and a rotary bolt interface wherein the shaft long side is between the blade springs and into the shaft hole; a cover plate releasably secured to the base and including a shaft hole with the shaft short side rotatably disposed therein; and a lever assembly co-rotated with the rotary bolt and releasably secured to a casement, the cover plate, and the base.

### BACKGROUND OF THE INVENTION

1. Field of the Invention

The invention relates to window lock latches and more particularly to a casement latch with fix position device.

2. Description of Related Art

A conventional latch for a casement window is shown in FIGS. 7 and 8 and comprises a cover plate, a rotary bolt, a base, and an elongated surface plate. The base and the surface plate are secured together by riveting, and the base and the cover plate are secured together by riveting too.

However, its rotary bolt is free to rotate and is impossible of stopping the rotary bolt in locked and unlocked positions. As a result, a user is not sure whether the casement window is locked or not. Moreover, the rotary bolt may fall due to gravity when the latch is mounted vertically. As a result, the locking function is compromised. In addition, the riveting is a time consuming and labor intensive process. Further, its yield is low.

Thus, the need for improvement still exists.

### SUMMARY OF THE INVENTION

It is therefore one object of the invention to provide a casement latch comprising a base including a recess, a shaft hole, first and second sets of two raise plates, a first stop surface on a wall of the recess, and a second stop surface on the wall of the recess, and a slide accepter between the first stop surface and the second stop surface; a surface plate releasably secured to the base and including an intermediate rectangular cut; a strike configured to releasably secure to a casement frame and including an intermediate rectangular cut member; two opposite blade springs each fastened between the raise plates of the first set of raise plates or the second set of raise plates; a rotary bolt including a bolt hook, a shaft short side on a first surface, a shaft long side on a second surface opposing the shaft short side, a square hole through the shaft short side and the shaft long side, four spaced square cut surfaces formed on four edges of the shaft long side, four spaced curve positions each formed between two adjacent ones of the square cut surfaces, a lower interface formed on the bolt hook, and an upper interface formed on the bolt hook wherein the shaft long side is disposed between the blade springs and into the shaft hole; a cover plate releasably secured to the base and including a shaft hole member with the shaft short side rotatably disposed therein wherein the assembled base, the cover plate, and the rotary bolt are configured to dispose in a casement; and a lever assembly releasably secured to the casement, the cover plate, and the base and including a square spindle inserted through the casement and the shaft hole member into the square hole, and a lever configured to co-rotate with the square spindle; wherein in response to a 90-degree clockwise turning the lever, the rotary bolt clockwise turns to cause the curve positions of the shaft long side to further bend the blade springs, cause the square cut surfaces of the shaft long side are clamped the blade springs and cause the first stop surface to stop at the upper interface, thereby fixed the position of the rotary bolt at locking position; and wherein in response to a 90-degree counterclockwise turning the lever, the rotary bolt counterclockwise turns to cause the curve positions of the shaft long side to bend the blade springs, cause the square cut surfaces of the shaft long side are clamped by the blade springs, and cause the second stop surface to stop at the lower interface, thereby fixed the position of the rotary bolt at unlocking position.

The above and other objects, features and advantages of the invention will become apparent from the following detailed description taken with the accompanying drawings.

### BRIEF DESCRIPTION OF THE DRAWINGS

FIG. 1 is an exploded view of main parts of a casement latch with fix position device according to the invention;

FIG. 2 is a front view of the assembled casement latch;

FIG. 2A is a cross-sectional view of the snap member;

FIG. 3 is a sectional view taken along line 3-3 of FIG. 2 but with the snap member removed;

FIG. 4 is a perspective view of the rotary bolt;

FIG. 4A is a cross-sectional view of a rotary bolt according to another configuration;

FIG. 5 is an exploded, all parts of the casement latch and perspective view of the lever assembly;

FIG. 6 is an exploded view showing the installation of the casement latch in a casement;

FIG. 7 is an exploded view of a conventional casement latch; and

FIG. 8 is a perspective view of the assembled casement latch of FIG. 7.

### DETAILED DESCRIPTION OF THE INVENTION

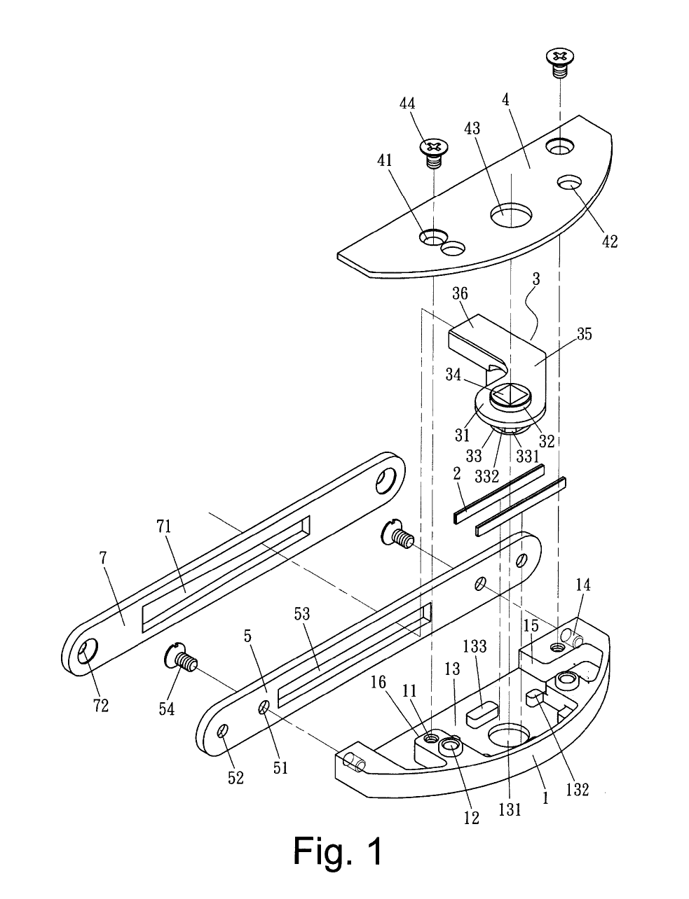

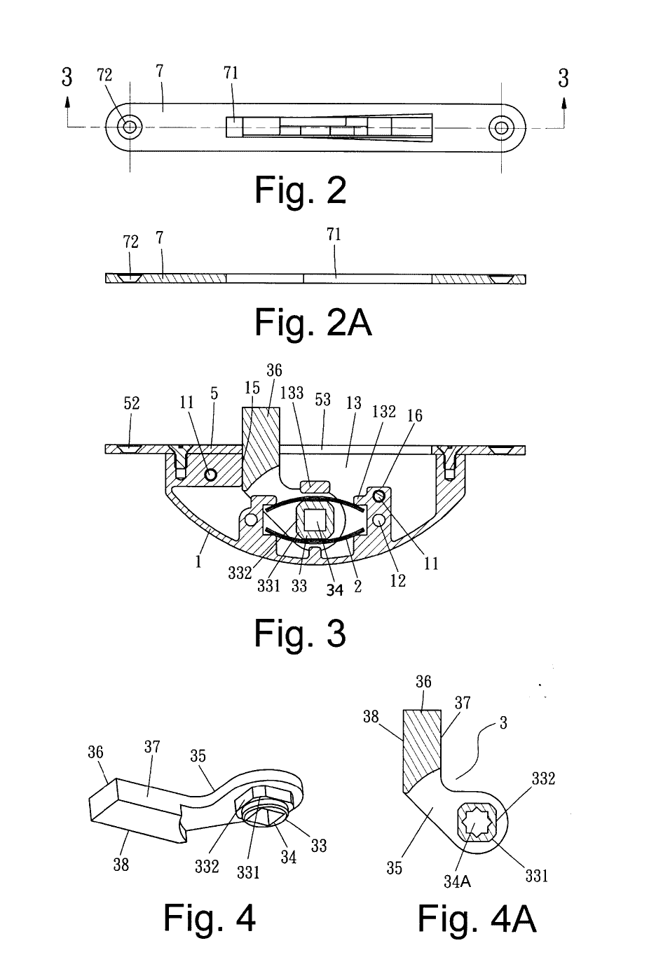

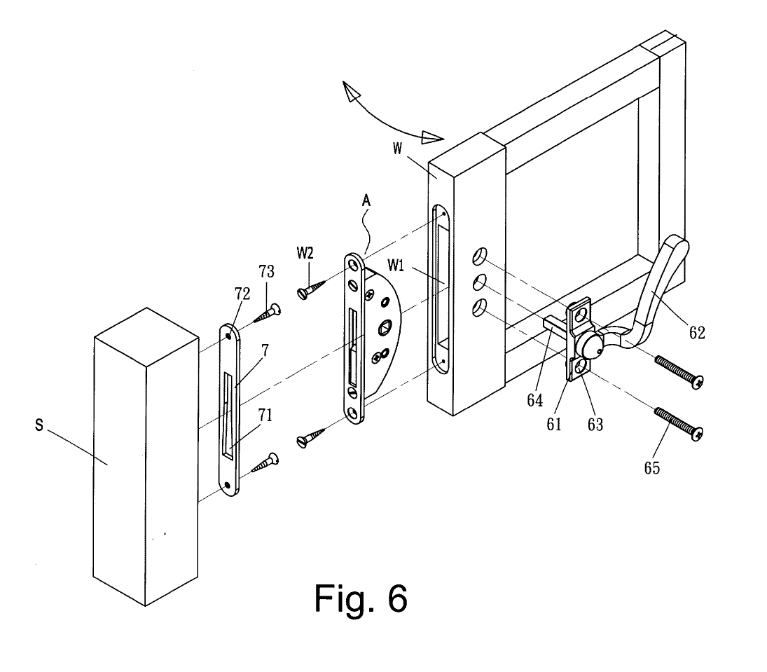

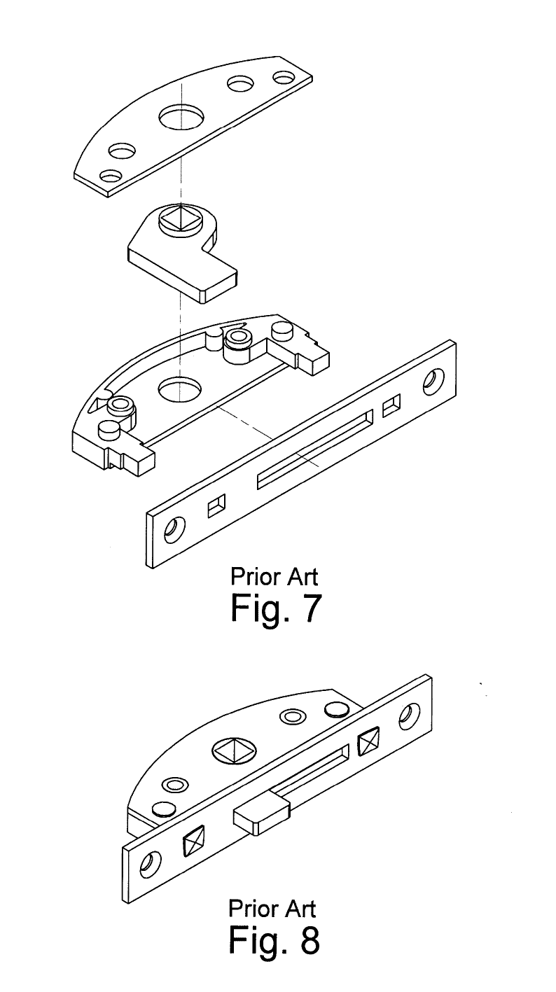

Referring to FIGS. 1 to 6, a casement latch A in accordance with the invention comprises the following components as discussed in detail below.

A base 1 has a flat first edge and a curved second edge opposing the first edge. The base 1 includes two thread holes 11; two anchor thread through holes 12; a concave position 13 having a shaft hole 131, four raise plates 132 at four corners of a virtual rectangle, and a slide accepter 133 between the raise plates 132; two thread holes 14 at respective ends of the flat first edge; a first stop surface 15 on a wall of the concave position 13 adjacent to one thread hole 11 and one raise plate 132; and a second stop surface 16 on the wall of the concave position 13 adjacent to the other thread hole 11 and two anchor thread through holes 12.

An elongated surface plate 5 includes an intermediate rectangular cut 53; two thread holes 52 at two ends respectively; two through holes 51 each between one thread hole 52 and the rectangular cut 53 or between the other thread hole 52 and the rectangular cut 53; and two bolts 54.

An elongated strike 7 includes a rectangular cut 71 and two fix holes 72 at two ends respectively. Two elongated blade springs 2 are provided in which one blade spring 2 is disposed between the two raise plates 132 and the other blade spring 2 is disposed between the other two raise plates 132 in a first step of assembly.

A rotary bolt 3 includes a circular disc 31; a shaft short side 32 on one surface; a shaft long side 33 on the other opposite surface, the shaft long side 33 having a height greater than that of the shaft short side 32; four spaced square cut surfaces 332 formed on four edges of the shaft long side 33; four spaced curve positions 331 each formed between two adjacent square cut surfaces 332; a square hole 34 through the shaft short side 32 and the shaft long side 33, the square hole 34 having a square section (see FIG. 3) or a double square hole 34A having a multi-angle interior surface (see another configuration in FIG. 4A); a bolt sloped surface 35 having one end formed with the circular disc 31; a bolt hook 36 formed with the other end of the bolt sloped surface 35; a lower interface 37 on one surface of the bolt hook 36; and an upper interface on the other surface of the bolt hook 36 opposite to the lower interface 37. In a second step of the assembly, the shaft long side 33 is inserted through a space between the blade springs 2 into the shaft hole 131 to be held in place.

A cover plate 4 is shaped the same as the base 1 and includes two fix holes 41; two through position holes 42; a shaft hole 43; and two bolts 44. In a third step of the assembly, the cover plate 4 is put on the base 1 with the shaft short side 32 rotatably disposed in the shaft hole 43. In a fourth step of the assembly, each bolt 44 is driven through the fix hole 41 into the thread hole 11 to fasten the cover plate 4 and the base 1 together. In a fifth step of the assembly, the assembled housing (including the base 1 and the cover plate 4) and the surface plate 5 are attached with the thread holes 14 aligned with the through holes 51 respectively. In a sixth step of the assembly, the bolts 54 are driven through the through hole 51 into the thread hole 14 to fasten the surface plate 5 and the base 1 (i.e., the housing) together with the bolt hook 36 projecting out of the rectangular cut 53. In a seventh step of the assembly, the rotary bolt 3 are disposed in a cut W1 for casement latch of a vertical portion of a casement W, two wooden screws W2 are driven through the thread holes 52 into the casement W to fasten them together, and two wooden screws 73 are driven through the fix holes 72 into a casement frame S to fasten the strike 7 and the casement frame S together.

A lever assembly 6 includes a base plate 61; two fix holes 63 at two ends of the base plate 61 respectively; a square spindle 64 having a square section projecting out of an inner surface of the plate 61, the square spindle 64 inserted through the shaft hole 43 into the square hole 34 to be held in place; a lever 62 having one end co-rotated with the square spindle 64; and two bolts 65 driven through the fix holes 63, the casement W, and the through position holes 42 into the anchor thread through holes 12 to fasten the lever assembly 6, the casement W, the cover plate 4 and the base 1 together in which the square spindle 64 is inserted through the casement W into the square hole 34 so that a rotation of the lever 62 rotates the square spindle 64.

A locking operation of the invention is discussed below. An operator may clockwise turn the lever 62 and thus the square spindle 64 which clockwise turns the rotary bolt 3. And in turn, the blade springs 2 are bent further by the curve positions 331 of the shaft long side 33. The turning of the rotary bolt 3 is 90-degree. At the end of the turning two opposite ones of the square cut surfaces 332 of the shaft long side 33 are clamped by the blade springs 2. Also, the upper interface 38 is stopped by the first stop surface 15. As a result, the rotary bolt 3 is locked and fastened at the locked position. Moreover, the bolt hook 36 inserts through the rectangular cut 71 into the recess of the casement frame S and a vertical portion of the casement W draws against the casement frame S to lock the casement window.

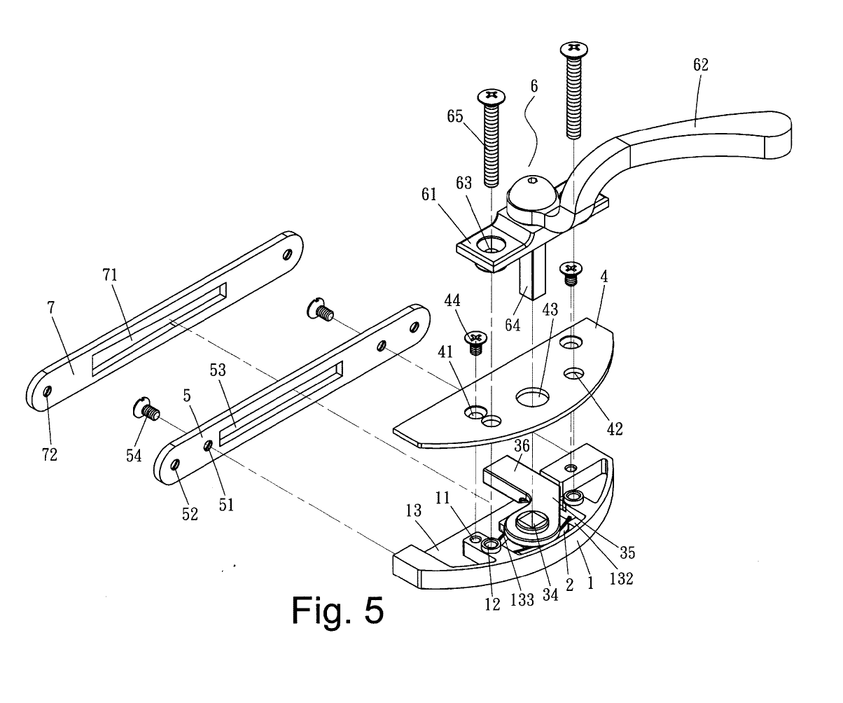

It is envisaged by the invention that the rotary bolt 3 is held in place because the opposite square cut surfaces 332 of the rotary bolt 3 are clamped by the blade springs 2 (see FIG. 5).

To the contrary, the operator may counterclockwise turn the lever 62 and thus the square spindle 64 which counterclockwise turns the rotary bolt 3. And in turn, the blade springs 2 are less bent by the curve positions 331 of the shaft long side 33. The turning of the rotary bolt 3 is 90-degree. At the end of the turning two opposite ones of the square cut surfaces 332 of the shaft long side 33 are clamped by blade springs 2. Also, the lower interface 37 is stopped by the second stop surface 16. As a result, the rotary bolt 3 is unlocked. Moreover, the bolt hook 36 retracts out of the recess of the casement frame S and the rectangular cut 71. The vertical portion of the casement W disengages from the casement frame S to unlock the casement window.

It is envisaged by the invention that the rotary bolt 3 is held in place because the opposite square cut surfaces 332 of the rotary bolt 3 are clamped by the blade springs 2.

While the invention has been described in terms of preferred embodiments, those skilled in the art will recognize that the invention can be practiced with modifications within the spirit and scope of the appended claims.

What is claimed is:

1. A casement latch comprising:
a base including a recess, a shaft hole, first and second sets of two raise plates, a first stop surface on a wall of the recess, and a second stop surface on the wall of the recess, and a slide accepter between the first stop surface and the second stop surface;
a surface plate releasably secured to the base and including an intermediate rectangular cut;
a strike configured to releasably secure to a casement frame and including an intermediate rectangular cut member;
two opposite blade springs each fastened between the raise plates of the first set of raise plates or the second set of raise plates;
a rotary bolt including a bolt hook, a shaft short side on a first surface, a shaft long side on a second surface opposing the shaft short side, a square hole through the shaft short side and the shaft long side, four spaced square cut surfaces formed on four edges of the shaft long side, four spaced curve positions each formed between two adjacent ones of the square cut surfaces, a lower interface formed on the bolt hook, and an upper interface formed on the bolt hook wherein the shaft long side is disposed between the blade springs and into the shaft hole;
a cover plate releasably secured to the base and including a shaft hole member with the shaft short side rotatably disposed therein wherein the assembled base, the cover plate, and the rotary bolt are configured to dispose in a casement; and
a lever assembly releasably secured to the casement, the cover plate, and the base and including a square spindle inserted through the casement and the shaft hole member into the square hole, and a lever configured to co-rotate with the square spindle;
wherein in response to a 90-degree clockwise turning the lever, the rotary bolt clockwise turns to cause the curve positions of the shaft long side to further bend the blade springs, cause the square cut surfaces of the shaft long side are clamped the blade springs and cause the first stop surface to stop at the upper interface, thereby fixed the position of the rotary bolt at locking position; and
wherein in response to a 90-degree counterclockwise turning the lever, the rotary bolt counterclockwise turns to cause the curve positions of the shaft long side to bend the blade springs, cause the square cut surfaces of the shaft long side are clamped by the blade springs, and cause the second stop surface to stop at the lower interface, thereby fixed the position of the rotary bolt at unlocking position.
